(19) United States
(12) Patent Application Publication
(10) Pub. No.: US 2010/0091888 A1
(43) Pub. Date: Apr. 15, 2010

(54) Multi-Rate Encoder with GOP Alignment

(75) Inventor: Robert S. Nemiroff, Carlsbad, CA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 12/250,317

(22) Filed: Oct. 13, 2008

(51) Int. Cl. H04N 7/26

(52) U.S. Cl. 375/240.28; 375/E07.154

(57) ABSTRACT

A multi-rate encoder includes one or more encoder sets. Each encoder set includes multiple encoders receiving a same video source stream. The encoder sets are configured to transmit multiple encoded streams of the same video source stream at different bit-rates. The streams are aligned and transmitted from the multi-rate encoder.

### RELATED APPLICATIONS

This patent application is related to U.S. Pat. No. 6,694,060, titled, “Frame Bit-Size Allocation For Seamlessly Spliced, Variable-Encoding-Rate, Compressed Digital Video Signals,” filed on Dec. 21, 2000. The above-identified patent are hereby incorporated by reference in their entireties.

### BACKGROUND

Satellite and digital cable high definition (HD) television are available in the television industry today. Now, however, telephone companies are improving the technology of Internet Protocol Television (IPTV) to establish IPTV as an alternative that is more desirable than satellite and cable television. Therefore, one goal of IPTV is to competitively offer HD television, and more. Telephone companies contemplate this via “triple play,” a subscriber service of voice, data, and video.

One challenge, however, involves a transmission bottleneck due to the narrow “copper pipe” (narrow bandwidth) through which video data must travel in the “last mile” of the path of transmission between a digital television service provider and a subscriber home. Conventionally, the DSLAM (digital subscriber line access manager) marks the “edge” or beginning of the “last mile” in IPTV. Typically, a wide “fiber optic pipe” having an abundance of bandwidth leads to the DSLAM. And, the narrow copper pipe connects the DSLAM to the subscriber premises. Essentially, the copper pipe is the traditional telephone line infrastructure that already exists.

One particular issue with the copper pipe is that it rapidly attenuates video data with distance and therefore the bandwidth of the copper pipe substantially degrades from its peak bit-rate the further the distance from the DSLAM to the subscriber. A subscriber who is too far from the DSLAM has an impaired subscriber connection. An impaired subscriber connection is characterized as having less throughput than the peak bit-rate of whatever physical medium transmission technology is used to convey data across the physical medium.

Typically in IPTV, a channel is not transmitted from the DSLAM to the subscriber unless a subscriber has specifically requested to view the channel. In this regard, consider three scenarios involving a second person requesting to view a second channel when a first viewer is already viewing a first program.

In the first scenario, an HD channel is 8 Mbps. An SD (standard definition) channel is 4 Mbps. The copper pipe between the DSLAM and a particular subscriber premises is characterized as having a bandwidth of 12 Mbps in total. One viewer at the subscriber premises is watching a television program on an HD channel (8 Mbps). Another viewer at the same subscriber premises, using a different television, then attempts to watch a different program on an SD channel (4 Mbps). Because the bandwidth requested is 12 Mbps in total (8 Mbps+4 Mbps=12 Mbps), both viewers have a positive experience of watching the television programming each requested to watch.

In the second scenario, nearly all circumstances are the same except the subscriber connection is an impaired connection having available bandwidth of only 11 Mbps in total. In this second scenario, the subscriber premises is further from the DSLAM when compared the subscriber premises in the first scenario, and thus there is less bandwidth available. The first viewer is watching 1 SD channel (4 Mbps) and the second viewer requests 1 HD channel (8 Mbps). Here, the question is: what is the desired outcome? If the system grants priority to the most recent request of the second viewer and entirely shuts down service to the first viewer due to insufficient bandwidth, then it is likely that the first viewer will be unhappy. Further, the consequence of denial is 3 Mbps of unused bandwidth in total (11 Mbps−8 Mbps=3 Mbps).

In the third scenario, there is also an impaired connection having available only 11 Mbps of bandwidth in total. The first viewer is watching 1 HD channel (8 Mbps) and the second viewer requests 1 SD channel (4 Mbps). Here, the question again is: what is the desired outcome? If the system grants priority to the more recent request of the second viewer and entirely shuts down service to the first viewer due to insufficient bandwidth, then it is likely the first person will be unhappy. Perhaps the first person will be particularly unhappy to know that the consequence of denial is 7 Mbps of unused bandwidth in total (11 Mbps−4 Mbps=7 Mbps). Not to mention, the service provider will also be unhappy that 7 Mbps of available bandwidth are unused.

It would therefore be beneficial to have a system which maximizes the available bandwidth and minimizes the disruption to viewing experience in situations involving requests for more video data than can actually fit through the pipe.

### BRIEF DESCRIPTION OF THE DRAWINGS

Features of the present invention will become apparent to those skilled in the art from the following description with reference to the figures, in which:

FIG. 1A shows a simplified block diagram of a GOP (Group of Pictures)-aligning multi-rate encoding system configured to perform various functions described herein, according to an embodiment of the invention;

FIG. 1B shows a simplified block diagram of a GOP-aligning multi-rate encoding apparatus configured to perform various functions described herein including rate control by transport rate buffering, according to an embodiment of the invention;

FIG. 1C shows a simplified block diagram of a GOP-aligning multi-rate encoding apparatus also configured to perform various functions described herein including rate control by preprocessing and/or multi-pass coding, according to another embodiment of the invention;

FIG. 2 illustrates a flow diagram of a method for aligning GOPs and rate control by transport rate buffering, according to an embodiment of the invention;

FIG. 3A illustrates a flow diagram of a method for aligning GOPs, and rate control by preprocessing according to an embodiment of the invention;

FIG. 3B illustrates a flow diagram of a method for aligning GOPs, and rate control by multi-pass coding according to an embodiment of the invention; and

FIG. 4 shows a block diagram of a computer apparatus configured to implement or execute the methods illustrated in FIGS. 2, 3A, and 3B, according to an embodiment of the invention.

### DETAILED DESCRIPTION OF THE INVENTION

For simplicity and illustrative purposes, the present invention is described by referring mainly to embodiments thereof. In the following description, numerous specific details are set forth in order to provide a thorough understanding of the embodiments. It will be apparent however, to one of ordinary skill in the art, that the embodiments may be practiced without limitation to these specific details.

Systems and methods disclosed herein cost effectively maximize bandwidth on a subscriber-per-subscriber basis in a manner that minimizes disruption of viewing experience. An encoding system, according to an embodiment, is configured to provide the same channel, e.g., the same video data, at different bit rates. This can be used to accommodate varying bandwidths for different subscribers connected to the same narrow copper pipe in the “last mile.” For example, in the second and third scenarios described above, instead of denying service to one of the viewers trying to watch a particular channel, the encoding system provides the channel at a lower bandwidth. As an example in the second scenario, video data of the first channel may be provided at 7 Mbps instead of 8 Mbps. In the third scenario, the video data of the first channel may be provided at 3 Mbps instead of 4 Mbps. The subscriber may perceive a slight degradation in service, but the service is tolerable, especially with respect to the alternative of not receiving the channel at all.

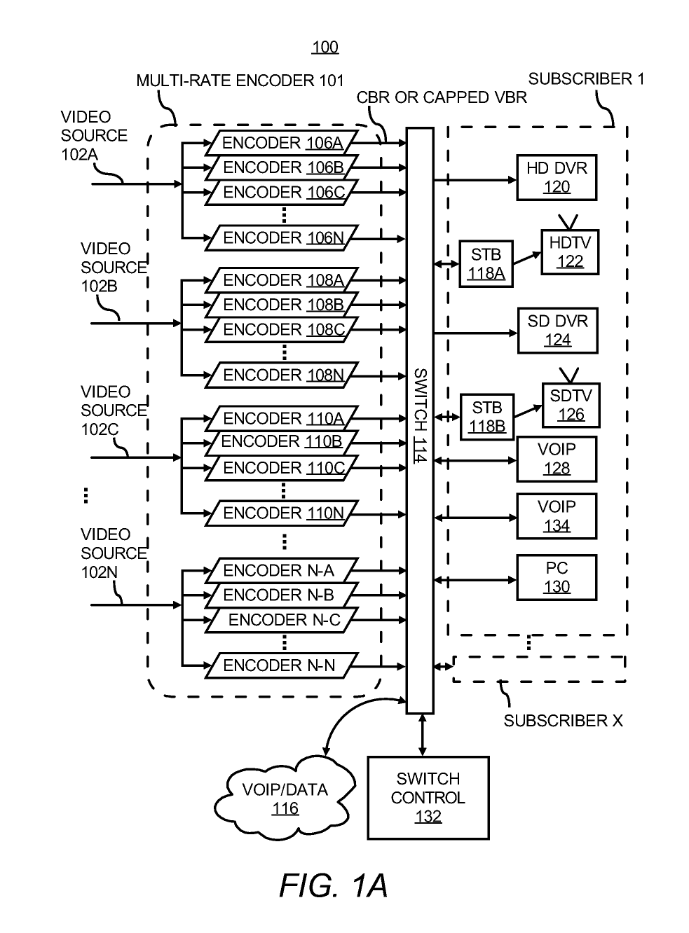

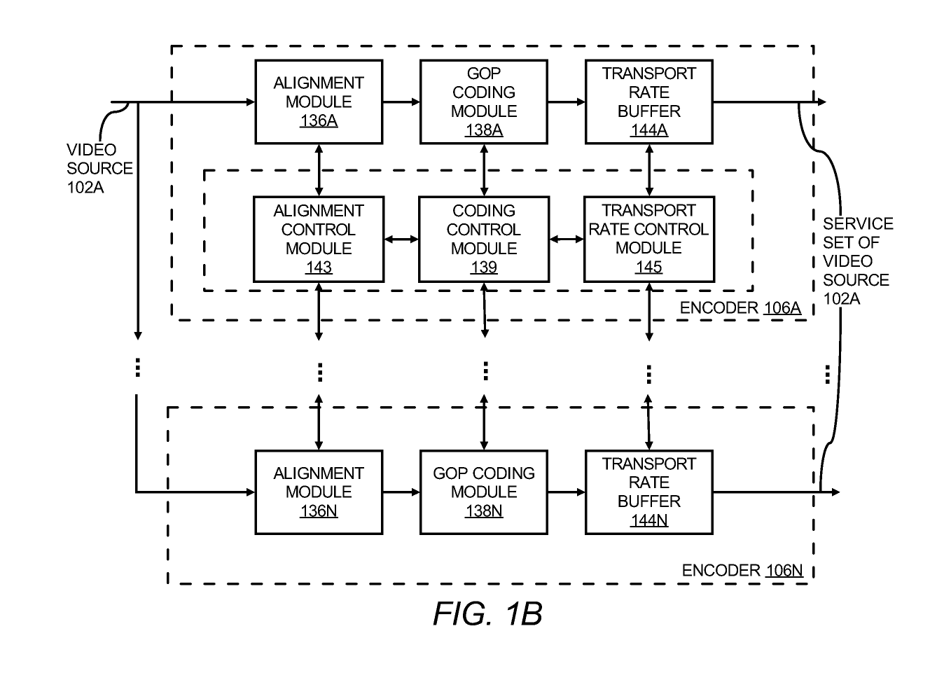

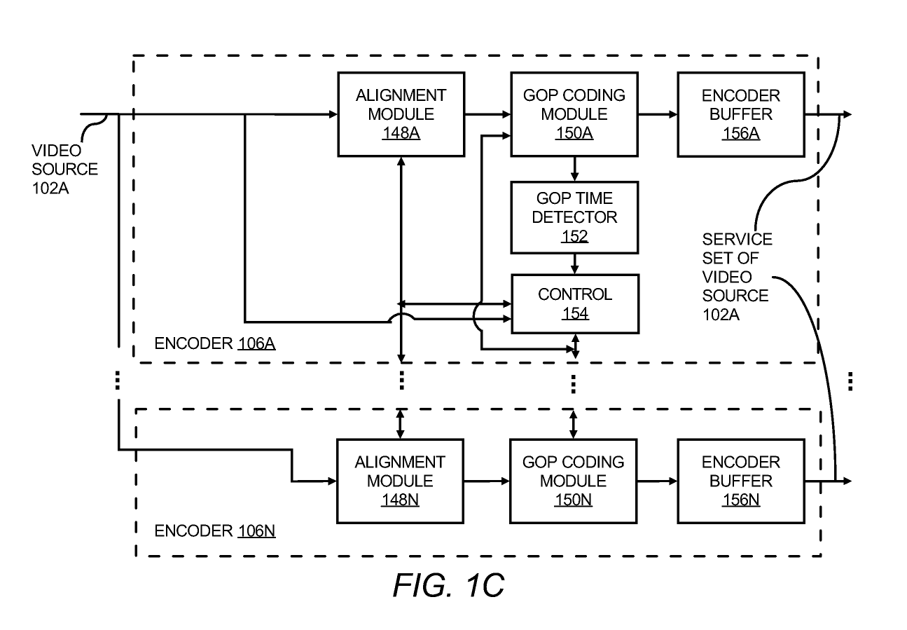

Turning first to FIG. 1A, there is shown a block diagram of a GOP-aligning multi-rate encoding system 100, according to an embodiment of the present invention. It should be understood that the encoding system 100 may include additional components and that some of the components described herein may be removed and/or modified without departing from the functionality of the encoding system 100.

The multi-rate encoding system 100 includes a multi-rate encoder 101, encoder set 106_{A-N} through encoder set N_{A-N} switch 114, switch control 132, and VoIP/data 116. In addition, the multi-rate encoding system 100 includes Subscriber 1. Subscriber 1, for example, includes two set top boxes (STBs 118A and B), one HD digital video recorder (HD DVR 120), one HD television (HDTV 122), one SD digital video recorder (SD DVR 124), one SD television (SDTV 126), two Internet Protocol telephones (VOIP 128 and 134), and one personal computer (PC 130). Not shown is customer premises equipment (CPE) for Subscriber 2 through Subscriber X. However, it should be clear that Subscriber 2 through Subscriber X may include CPE similar to Subscriber 1, including any combination thereof.

The multi-rate encoder 101 receives a plurality of video sources 102A through 102N. As an example, the video source 102A will be discussed. The video source 102A includes video data received from a broadcaster or some other video data source, and the multi-rate encoder 101 may be located in a central office, head end, neighborhood node, or other location for receiving the video source 102A. The video source 102A may be received via satellite broadcast, fiber transmission, Internet, private wideband backbone, or via other known transmission media. The video source 102A may include programming that had been stored remotely before it was received. Also, the video source 102A may be locally stored after it is received. Further, the video source 102A may be received according to one or more schedules. In addition, the video source 102A may be received via multicast transmission (transmission to multiple destinations) or unicast transmission (transmission to one destination). For instance, the video source 102A may be video on demand (VOD) which may be transmitted to one destination. In addition, the video source 102A may be received as in different formats including HD, SD, or other well known video digital data formatting and/or standard. Each of the video sources 102B through 102N are similar to the video source 102a, as will be discussed.

The multi-rate encoder 101 includes the encoder sets 106_{A-N} through N_{A-N}. For instance, the encoder set 106 includes the encoders 106A through 106N for encoding the video source 102A into multiple streams of encoded video data at different bit rates. Further, each of the remaining encoder sets 108_{A-N} through N_{A-N} receives a corresponding video source 102B through 102N. Each of the video sources 102A through 102N represents a different channel. For instance, each of the video sources 102A through 102N may be a different multicast channel, such as ABC, NBC, CBS, FOX, etc. Also, each of the video sources 102A through 102N may be a different unicast channel such as VOD. Essentially, each of the video sources 102A Through 102N may generally represent video data including different content. Also, each of the encoder sets 106_{A-N} through N_{A-N} encodes the corresponding channel into a corresponding service set of multiple streams of video data having different bit rates.

The video source 102A is an original stream. For example, the original stream is a stream of uncompressed image frames received, for instance, at a rate of approximately 30 frames per second. In this regard, the video source 102A is characterized as “raw video.” Therefore, the video source 102A may be in a well known format such as a 4:2:2 format. It should be clear however, the video source 102A may be of a different format from 4:2:2 such as in a 4:2:0 format, or in other well known appropriate formats.

Assume an example involving ADSL2+ (Asymmetric Digital Subscriber Line 2+) which comprises a bit-rate of 24 Mbps in total (between the encoder set 106_{A-N} and the premises of Subscriber 1. In this example, the encoder set 106_{A-N} encodes the video source 102A, and the video source 102A is one HD channel of video data. In this regard, after encoding by encoder 106A, the bit-rate of the encoded video source 102A is 8 Mbps in total.

In this example, assume further, the encoder set 106_{A-N} comprises 4 encoders. Therefore, the encoder set 106_{A-N} includes the encoders 106A through 106D. Each of the remaining encoders 106B through 106D encodes the video source 102A at different lower bit rates. For example, the encoder 106B is a 90% bit-rate encoder having a 10% loss and thus a throughput of 7.2 Mbps in total (8 Mbps×0.90=7.2 Mbps). The encoder 106C is an 80% bit-rate encoder having a 20% loss and thus a throughput of 6.4 Mbps in total (8 Mbps×0.80=6.4 Mbps). Finally, the encoder 106D is a 70% bit-rate encoder having a 30% loss and thus a 5.6 throughput of 5.6 Mbps in total (8 Mbps×0.70=5.6 Mbps). It can be said that these four streams of encoded video data at different bit-rates is a service set of video source 102A.

Note also that each encoder in encoder set 106_{A-N} may comprise capped bit rate encoding. For instance, the video source 102A may be encoded by encoder 106A at a lower bit-rate than a constant bit-rate of 8 Mbps in total. Capped bit-rate encoding may be employed in situations involving lower complexity such as very little change in picture information from one picture to another picture. In this regard, the capped bit-rate encoding by the encoder 106A may be employed when such encoding at a lower bit-rate results in no degradation of the quality of viewing experience when compared to encoding at a constant bit rate. When the encoder 106A encodes at a capped bit-rate, the encoder 106B encodes at a rate of 90% of the capped bit-rate of the encoder 106A, the encoder 106C encodes at a rate of 80% of the capped bit-rate of the encoder 106A, and the encoder 106D encodes at a rate of 70% of the capped bit-rate of the encoder 106A.

In a scenario, a first viewer at Subscriber 1 watches the video source 102A (1 HD channel) via HDTV 122. Using an HD video recorder (DVR 120), the first viewer also records another HD channel, for instance the video source 102B. Therefore, the first viewer is using a bandwidth of 16 Mbps in total (8 Mbps+8 Mbps=16 Mbps). At the same time, a second viewer at Subscriber 1 attempts view source 102C of an SD channel (4 Mbps) on a standard definition television (SDTV 126). Using a standard definition digital video recorder or the SD DVR 124, the second viewer also attempts to record another SD channel (4 Mbps) of the video source 102N. In this example, the bandwidth needed of 24 Mbps in total (8 Mbps+8 Mbps+4 Mbps+4 Mbps=24 Mbps) and exceeds the available bandwidth of 22.8 Mbps.

Given that the needed bandwidth exceeds the available bandwidth, the switch control 132 selects, on a channel-by-channel basis, one or more video streams having lower bit rates in order to provide all the desired channels to Subscriber 1. For instance, depending on bandwidth availability, complexity of each video channel, and weight of each service, the switch control 132 determines which encoded bit rate stream, from the service sets for the video sources 102A through 102N, to send to the Subscriber 1. In one example, complexity can be received by the switch control 132 as side information or meta data. In another example, Subscriber 1 has customized the settings of the Subscriber 1's service and thereby biased specific channels and/or specific programming. For instance, Subscriber 1 has given priority to all sports events when broadcast in high definition. Thus, for example, the switch 114, under control of the switch control 132, automatically switches from the 100% encoded video stream to the 90% encoded video stream of the high definition channel corresponding to the video source 102A. In this regard, all four channels are sent to Subscriber 1 and the video source 102A which is of least value to the subscriber (e.g., based on a subscriber preference) is mildly degraded instead of denied. Note that this involves use of the entire available bandwidth of 22.8 Mbps in total (7.2 Mbps+8 Mbps+4 Mbps+3.6 Mbps=22.8 Mbps).

Although not specifically discussed, each Subscriber 2 through X may request content requiring varying amounts of bandwidth. Similar to the example involving Subscriber 1, any number of factors may cause the switch control 132 to switch among the service set of any given channel. When bandwidth-demand exceeds bandwidth-availability in an example involving Subscriber 2 for instance, the switch control 132 automatically controls the switch 114 to select among different bit-rates of a channel requested by Subscriber 2 based on similar criteria.

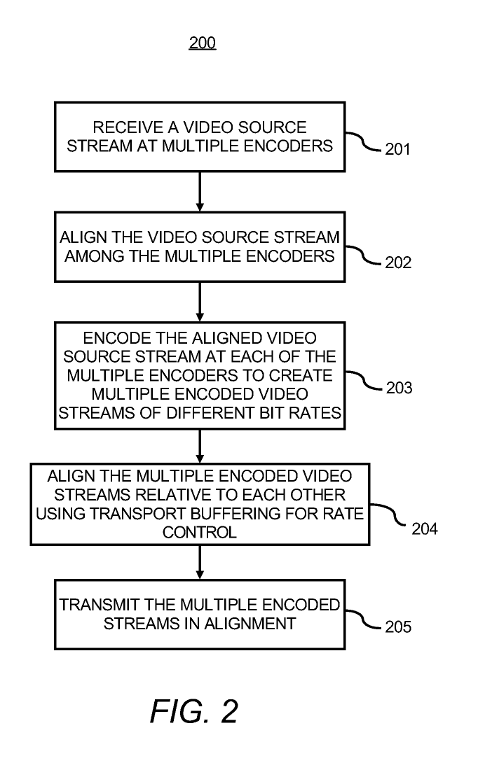

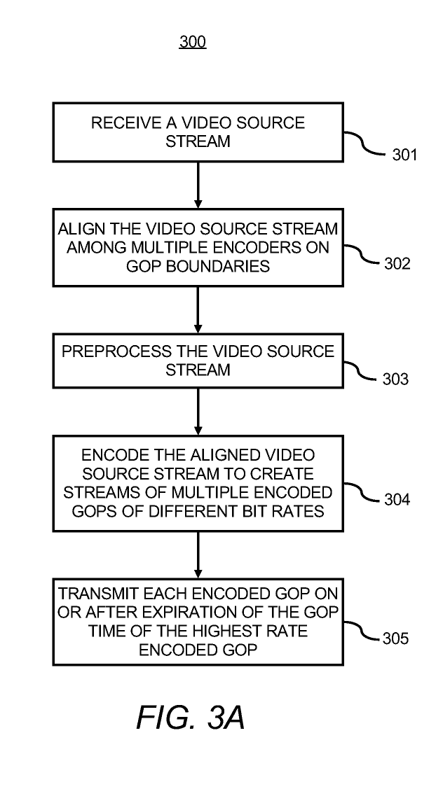

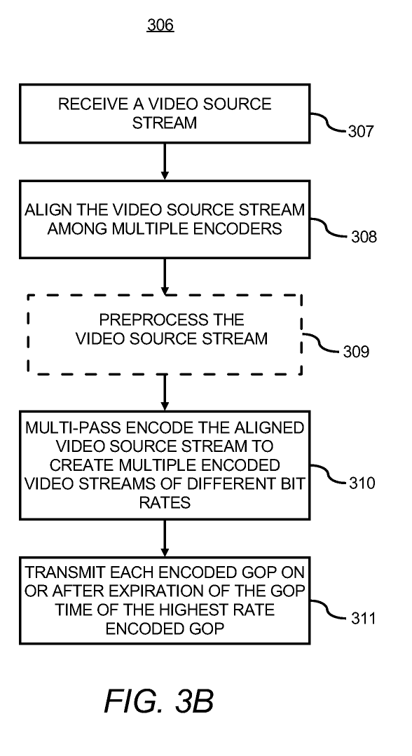

Note also that each of the encoder sets 106_{A-N} through N_{A-N} may operate according to various embodiments of the present invention including the embodiments shown FIGS. 1B and 1C as well as those illustrated in methods of FIGS. 2, 3A, and 3B.

FIG. 1B shows modules and hardware for encoders in an encoder set 106A-N according to an embodiment. Note that this disclosure of the embodiment of FIG. 1B is applicable to any of the encoder sets 106A-N through NA-N shown in FIG. 1A. FIG. 1B shows the encoder 106A of the encoder set 106A-N which includes an alignment module 136A, an alignment control module 143, a GOP coding module 138A, a coding control module 139, a transport rate buffer 144A, and a transport rate control module 145. Note that in embodiment of FIG. 1B, the encoder 106A and the encoder 106N are shown whereas the encoders 106B through 106N-1 are not shown. Although the encoders 106B through 106N-1 are not shown, the encoders 106B through 106N-1 include the features shown for encoder 106N.

Essentially, the encoder 106A is a master encoder and the encoders 106B through 106N are slave encoders. For instance, the slave encoders 106B through 106N-1 include the features shown for the slave encoder 106N but may not include the features shown for the master encoder 106A. Therefore, the encoders 106A through 106N respectively include a plurality of alignment modules 136A through 136N, a plurality of GOP coding modules 138A through 138N, and a plurality of transport rate buffers 144A through 144N. In contrast, the master encoder 106A includes more features than the slave encoders 106B through 106N such as the alignment control module 142, the coding control module 139, and the transport rate control module 145.

In an example, the video source 102A is simultaneously received by the encoders 106A through 106N from a Serial Digital Interface (SDI) port. Here, the video source 102A is raw video data. For example, the video source 102A has a 4:2:2 format. Note the video source 102A may comprise other formats too. For instance, the video source 102A may have a 4:2:0 format, or any other well format appropriate for this embodiment. The video source 102A comprises markers or flags which may be used to identify picture boundaries. For instance, the alignment modules 136A through 136N receive the video source 102A containing unencoded pictures in display order. Further, each of the alignment control modules 136A through 136N may identify picture boundaries in the video source 102A based on markers or flags in video source 102A.

Each of the alignment modules 136A through 136N is configured to identify boundaries of an unencoded picture. Further, each of the alignment modules 136A through 136N is configured to detect one or more characteristics/metrics of a particular unencoded picture. For instance, each alignment module 136A through 136N may detect an average number of bits in an identified unencoded picture, the DC level of an identified unencoded picture, the variance level of an identified unencoded picture, or whether there is a scene change at an identified unencoded picture. The alignment modules 136A through 136N may send one more of such metric to the alignment control module 143 (of the master encoder 106A). In this example, the master encoder's alignment control module 143 may compare the metrics received from the corresponding alignment modules 136A through 136N. Based on a match of same or similar metrics received from the corresponding alignment modules 136A through 136N, the alignment control module 143 may identify the same picture within the alignment modules 136A through 136N.

Once the alignment control module 143 identifies the same picture within the alignment modules 136A through 136N, the alignment control module 143 may control the alignment modules 136A through 136N to send the same unencoded picture from their respective input video source 102A to the corresponding GOP coding modules 138A through 138N.

The coding control module 139 (of the master encoder 106a) controls the GOP coding module 138A as well as the GOP coding modules 138B through 138N (of the slave encoders 106B through 106N). In this regard, the GOP coding modules 138A through 138N encode a same group of pictures beginning on the same boundary of the same picture. Furthermore, the coding control module 143 produces synchronization references, as will be discussed further below.

Once the GOP coding modules 138A through 138N receive the same unencoded picture, the coding control module 139 controls the GOP coding modules 138A through 138N to begin coding on the boundary of the same unencoded picture (at the start of the same picture). The same unencoded picture may be the first unencoded picture in a group of unencoded pictures of which the GOP coding modules 138A through 138N may encode.

Once the GOP coding modules 138A through 138N encode the same unencoded GOP, the GOP coding modules 138A through 138N continue on, and thus, receive subsequent unencoded GOPs beginning with the next unencoded GOP which following the first encoded GOP. The GOP coding modules 138A through 138N continue by encoding GOP-by-GOP, on the boundary the first unencoded picture which follows the last picture of the last encoded GOP. Note that prior to receiving the picture, each of the GOP coding modules 138A through 138N may be free running or may be idle.

Also, the GOP encoding modules 138A through 138N embed timing references in corresponding transport streams. In MPEG coding, these synchronization references include program clock references (PCRs). The master coding control module 139 controls the master GOP coding modules 138A and the slave GOP coding modules 138B through 138N so as to reference the same PCR. Because each of the encoders 138A through 138N embed the PCRs in transports streams, the decoder is also a type of slave with respect the same PCR “clock.” Essentially, the PCR “clock” is a sequential counter used by a decoder operating in a “push model” mode.

In addition, coding control module 139 controls the GOP encoding modules 138A through 138N to embed the same values of presentation time stamps (PTS) and decoder time stamps (DTS). In an example, the same PTS and DTS values may embedded in a corresponding picture encoded at different bit rates by the GOP coding modules 138A through 138N. Note that in this example embedded DTS' and PTS' may not be embedded in every picture. In another example, DTS' and PTS' may be embedded in every picture.

Once the GOP coding modules 138A through 138N complete encoding a GOP, the transport rate buffers 144A through 144N receive the encoded GOP at corresponding bit-rates of the encoders 106A through 106N. Also, the transport rate control module 145 receives timing information from the coding control module 139 to control the transport rate of the encoded GOP service set, as will be discussed further below.

By encoding with the same encoding algorithm and by beginning encoding on the same picture of an unencoded GOP, another feature becomes possible. A target ratio of gop_bits to bit-rate is the same for each of the encoders 106A through 106N (within some tolerance.) In an example involving the encoders 106A through 106N in which encoding begins on the boundary of a same picture of an unencoded GOP, each GOP coding module 138A through 138N uses the same encoding algorithm to encode the same received unencoded GOP. The transport rate control module 145, on a GOP-by-GOP basis, detects the actual time (gop_time) it takes for the GOP coding module 138A to transmit the group of pictures at the bit rate of the encoder 106A. The transport rate control module 145 may detect gop_time as follows:

$$gop\_time = \frac{GopBits 100 percentStream}{BitRate\_ 100 percentStream} \qquad Equation ( 1 )$$

In an example, the transport rate control module 145 sends the gop_time of the 100% stream to the lower rate GOP coding modules 138B through 138N. A target number of encoded gop_bits is determined by each GOP coding module 138B through 138N. Essentially, the target number of gop_bits is the number of bits that the encoding algorithm attempts to generate in the encoded GOP.

For instance, if the gop_time of the 100% bit-rate encoder 138A is 1 second, then the target number of gop_bits of the 90% bit-rate encoder is 90% of the gop_bits of the 100% rate encoder. Likewise, the target number of gop_bits of the 80% bit=rate encoder is 80% of the gop_bits of the 100% encoder, and so forth.

Note also that each encoded GOP may vary in time, due to variable length coding such as H.264. What this means is that each encoded GOP may vary in length. In one example, an unencoded GOP having a high level of complexity such as a scene change will tend to generate an encoded GOP having more gop_bits of greater gop_time, whereas an unencoded GOP having a low level of complexity such as a still frame video will tend to generate an encoded GOP of fewer gop_bits having less gop_time.

Due to the fact that the encoding algorithm may be inexact, the actual encoded gop_bits may slightly vary from the target gop_bits. To compensate, rate control is performed. For example, each GOP coding module 138A through 138N, on a GOP-by-GOP basis, sends corresponding encoded GOPs to the transport rate buffers 144A through 144N. In an example, each of the transport rate buffers 144a through 144N sends a value to the transport rate control module 145 which represents the actual number of bits in each corresponding encoded GOP. Once the transport rate control module 145 receives the value of the actual number of bits, the transport rate control module 145 determines the transport rate for each GOP service set as follows:

$$GopBitRateLowerRateEncoder = \frac{ActualGopBitsLowerRateStream}{gop\_time} \qquad Equation ( 2 )$$

Note that the denominator of this equation is the gop_time of the highest bit-rate encoder 106A as determined by Equation 1. Also note that a single GOP encoded at different bit-rates forms an encoded GOP service set. An encoded service set is a stream of encoded GOPs of different bit rates generated, for instance, by encoding GOPs of video source 102a. For instance, the video source 102a is a channel. Therefore, the combined output of the multi-rate encoder 106A through 106N is a service set of the same channel at different bit rates. Each of the coding modules 138A through 138N sends an encoded GOP of a different bit rate to the corresponding transport rate buffers 144A through 144N. Once the transport rate control module 145 determines the actual transport rate of each encoded GOP for a given GOP service set, the transport rate control module 145 controls the timing of transmission of the encoded GOP service set from the transport rate buffers 144a through 144n to the switch 114.

Using IP, each encoded GOP service set is transmitted from the transport rate buffers 144A through 144N to the switch 114 in a manner such that each encoded GOP begins at the same time and ends at the same time. In other words, each encoded GOP in a encoded given GOP service set is received at the same time at the switch 114 shown in FIG. 1A. For this reason, the switch 114 can seamlessly switch between different bit-rate streams of the same channel as may be needed.

The transport rate control module 145 may set the rate for each encoded GOP stream such that each encoded GOP stream should start and end at the same time. If the first encoded GOP starts at time=0, each transport rate buffer 144A through 144N starts sending its encoded GOP at time=0. Based on the gop_time and GopBitRateLowerRateEncoder, each encoded GOP also ends transmission at the same time. The next start of an encoded GOP will be time=0+(current) gop_time. In this regard, the switch 144 needs to wait for the start of an next encoded GOP of each stream before making the switch.

Note that requests for additional channels are processed at the encoding side of the DSL line. When an IPTV subscriber changes or adds a channel as in the above scenarios, the channel is actually remotely switched/selected using a so called request to join a new multicast group using Internet Protocol Group Membership Version 2 (IGMP). The local office receives the subscriber request, automatically checks to make sure that the subscriber is authorized to view the requested channel, and then directs one or more routers in the local office to add that particular subscriber to the distribution list of requested channel.

Returning to FIG. 1B, if a GOP service set was to arrive at the switch 114 at different times, then an automatic switching among different bit-rates of the same channel may result in a brief interruption of the viewing experience similar to that of from one channel to another channel. This problem, however, is avoided because each GOP service set is, on a GOP service-set by GOP service-set basis, aligned in the transport rate buffers 144A through 144N so as to be transmitted at the same time according to the control of transport rate control module 145. In addition, on a GOP-service-set by GOP-service-set basis, the switch 114 receives the beginning of each encoded GOP at the same time and receives the end of each encoded GOP at the same time. Note IP jitter may interfere with a perfect scenario in this regard. However, IP jitter may be accommodated by the design of the switch 114. Essentially, the switch 114 switches among different bit-rates of the same channel on the boundary of an encoded GOP service set. For instance, the first picture in an encoded GOP may be the MPEG image frame or I frame. Because a switch from one bit-rate to another bit-rate of the same channel occurs immediately after a last encoded GOP. And, because such a switch occurs on the I frame of a current GOP, the switch 114 seamlessly switches so that there is no glitch in viewing experience.

The video buffer verifier (VBV) is a mechanism by which an encoder and a corresponding decoder avoid overflow and/or underflow in video buffer of the decoder. For instance, H.264 specifies a 30 Mbit buffer at level 4.0 in the decoder of an HD channel. Also, the encoder keeps a running track of the amount of video data that it sends to the decoder. If the VBV is improperly managed, the video buffer of the decoder could underflow which means run out of video to display. In this scenario, the viewing experience involves dead time. Also, the VBV may overflow meaning that the decoder buffer cannot hold all of the data it receives. In this scenario, the excess data is dumped and the viewing experience is similar to an instant fast-forwarding similar to jumping forward in the video. Both scenarios are disruptive to the viewing experience. Note also that both video underflow and overflow cause video corruption. Video corruption can persist for the entire GOP since subsequent frames in that GOP use the past anchor frames (I and P) as reference. Essentially, data loss can produce video corruption.

Because each GOP service set of a channel arrives at the decoder at substantially the same time, and because the sync references (for instance, PCRs, PTSs, DTSs) of the same channel are transmitted by all encoders of a given channel to the decoder, each I frame of the channel arrives at the decoder before the DTS, regardless of the bit-rate. Therefore no VBV underflow will occur.

VBV overflow is also avoided even in extreme cases. For instance, a combination of a high bit-rate, long system delay, and low AVC level, which may otherwise result overflow, is avoided. In this regard, the GOP coding modules 138B through 138N (of slave encoders 106B through 106N) protect against VBV overflow. These coding modules track buffer levels to determine VBV fullness. However, as a decoder receives video immediately following a switch from a higher bit-rate to a lower bit-rate, the actual VBV fullness will be larger than the VBV fullness value that had been calculated by the lower bit-rate encoder. In this regard, the worst case scenario is the difference between VBV fullness values computed by the 100% bit-rate encoder and the lowest bit-rate encoder of any given channel. Here, the VBV delay is equal to the system delay. At this point, when the decoder buffer is large enough to handle the worst case scenario, the decoder buffer is at its fullest level and is equal to the bit-rate multiplied by the system delay. This difference, or offset, between the actual VBV fullness and the VBV fullness value of encoder(n), is computed as:

VBVFullnessOffset(n)=sysDelay*(bitRate_{—}100 percentStream−bitRateEnc(n)) Equation (3)

As an example, each of the lower-rate GOP coding modules 138B through 138N of an encoder set 106A-N determines a VBVFullnessOffset, subtracts this offset from the decoder buffer available size it would otherwise compute, and uses this result as an adjusted buffer available size. In this regard, the GOP coding modules 138B through 138N use the adjusted buffer available size for buffer protection and therefore VBV overflow is avoided. For AVC, this will typically have no effect on the rate control since the decoder buffer is much larger than is needed. For instance in a first scenario with a 10 Mbps stream having a 1 second system delay, the maximum decoder buffer fullness is 10 Mbps*1 sec=10 Mbits. For AVC at level 4.0 (for HD), the decoder buffer is 30 Mbits, so the VBV cannot overflow. VBVFullnessOffset at a 70% bit-rate is 10 Mbps*(1−0.7)*1.0 sec=3 Mbits. Therefore, this offset is small and has little to no effect on rate control.

Considering a second scenario with the same conditions as the first scenario except the standard is MPEG-2 or ATSC instead of AVC. A stream of 10 Mbps having a 1 second system delay will be coded to limit the decoder buffer level to the buffer size because the buffer size is about 9 Mbits for MPEG-2 and 8 Mbits for ATSC. If left unprotected, a system delay greater than 0.9 seconds can result in overflow for MPEG-2 (10 Mbps*0.9 sec=9 Mbits). Also, a system delay greater than 0.8 seconds can result in overflow for ATSC (10 Mbps*0.8 sec=8 Mbits). For this case, the VBVFullnessOffset at a 70% bit-rate is still 3 Mbits to protect the VBV buffer from overflow.

Considering a third scenario with a 7.5 Mbps stream having a 1.0 second system delay. The maximum decoder buffer fullness is 7.5 Mbits (7.5 Mbps*1.0 sec=7.5 Mbits). Here VBVFullnessOffset at a 70% bit-rate is 2.25 Mbits (1.0*(7.5 Mbps−(7.5 Mbps*0.7))=2.25 Mbits.) Thus, switching from the 100% stream to the 70% stream, the 70% stream encoder computes the VBV size as 5.25 Mbits (1 sec*7.5 Mbps*0.7=5.25 Mbits). However, prior to decoding the switch point, the true VBV size is 7.5 Mbits (5.25 Mbits+2.25 Mbits=7.5 Mbits). Therefore the 70% stream encoder must use the 7.5 Mbits value as buffer fullness when computing picture sizes in order to prevent overflow. If the VBV maximum buffer size is 8.0 Mbits, at the switch point, the 70% stream encoder has only 0.5 Mbits (8 Mbits−7.5 Mbits=0.5 Mbits) of VBV buffer available. Without considering the switch point, the 70% stream encoder would have computed the available VBV buffer level as 2.75 Mbits (8.0 Mbits−5.25 Mbits=2.75 Mbits).

Essentially, smaller decoder buffers and longer system delays may require lower bit rates. Put differently, higher bit rates and longer system delays may require larger decoder buffers to avoid overflow.

FIG. 1C shows a multi-rate encoder 100 according to another embodiment. The multi-rate encoder shown in FIG. 1C is essentially the same as the multi-rate encoder shown in FIG. 1B, except rate control is accomplished using preprocessing and/or multi-pass encoding instead of using the transport rate control of FIG. 1A (via the transport rate control buffers 144A through 144N and the transport rate control module 145). By using preprocessing and/or multi-pass encoding, the actual number of bits in an encoded GOP may more closely match the target number of bits in an encoded GOP not using preprocessing and/or multi-pass encoding.

FIG. 1C shows modules and hardware for encoders in an encoder set according to an embodiment. The encoders may be used for any of the encoder sets 106A-N through NA-N as described in the embodiment of FIG. 1A.

Similar to the embodiment of FIG. 1B, the encoder 106A in the embodiment of FIG. 1C is a master encoder and the encoders 106B through 106N in the embodiment of FIG. 1C are slave encoders. Like the embodiment of FIG. 1B, the encoder 106A and the encoder 106N in the embodiment of FIG. 1C are shown whereas the encoders 106B through 106N-1 are not shown. Although the encoders 106B through 106N-1 are not shown, the encoders 106B through 106N-1 include the features shown for encoder 106N.

Also, the alignment modules 148A through 148N in the embodiment of FIG. 1C operate in a manner similar to the above-disclosed alignment modules 136A through 136N in the embodiment of FIG. 1B, except the control 154 in the embodiment of FIG. 1C may perform the functions of the alignment control module 143 in the embodiment of FIG. 1B.

Differently than the embodiment of FIG. 1B, the embodiment of FIG. 1C includes a plurality of GOP coding modules 150A through 150N, the control 154, a gop_time detector 152, and a plurality of encoder buffers 156A through 156N. Rate control in the embodiment of FIG. 1C is accomplished by 1) aligning unencoded GOPs at the input of the GOP coding modules 150A through 150N so as to encode GOPs at the start of a same picture on the boundary of that same picture; 2) preprocessing these aligned unencoded GOPs in coding modules 150A through 150N; and/or 3) multi-pass encoding these aligned GOPs by coding modules 150A through 150N.

The control 154 (of the master encoder 106A) controls the GOP coding modules 150A (of the master encoder 106A) as well as the GOP coding modules 150B through 150N (of the slave encoders 106B through 106N). The GOP coding modules 150A through 150N encode a same group of pictures beginning on the same boundary of the same picture at the same time. Furthermore, the control 154 generates synchronization references and performs similar functions as the coding control module 139 in the embodiment of FIG. 1B.

The GOP time detector module 152, on a GOP-by-GOP basis, detects the actual time (gop_time) it takes for the GOP coding module 150A to transmit the group of pictures. In this regard, the GOP time detector module 152 detects gop_time pursuant to the above-described Equation (1).

The GOP coding modules 150A through 150N each receive an aligned unencoded GOP at the same time and, on a GOP-by-GOP basis, generate an (encoded) GOP service set of different bit-rates. When the ratio of the number of bits in an encoded GOP divided by the bit-rate of the encoder is the same for the encoded GOP generated by each encoder of an encoder set, rate control is accomplished.

Preprocessing is used to accomplish rate control in the embodiment of FIG. 1C. In this regard, the GOP coding modules 150A through 150N comprise preprocessing. Essentially preprocessing involves analyzing unencoded GOPs before encoding. For instance, the content of a picture can be analyzed for complexity and variance of complexity within a picture. Here, the purpose of preprocessing is to better estimate a bit budget of encoded GOP bits. In this regard, the closer the number of bits budgeted to the actual number of encoded GOP bits, the closer the match of GOPs generated from GOP coding modules 150A through 150N with regard to the ratio of number of encoded GOP bits divided by the bit-rate of the encoder.

Multi-pass encoding is also used to accomplish rate control in the example of FIG. 1C. In an example, the GOP coding modules 150A through 150N comprise multi-pass encoding alone or in combination with preprocessing. In an example, the same encoding algorithm is used by each of the GOP coding modules 150A through 150N. Due to the fact that the encoding algorithm may be inexact, the actual encoded gop_bits may slightly vary from the target gop_bits. To compensate, iterative multipass encoding is performed. Essentially, iterative multi-pass encoding improves the degree in which the actual number of encoded bits matches the target number of encoded bits. The closer the match, among the outputs of GOP coding modules 150A through 150N the closer the match with regard to the ratio of number of encoded GOP bits divided by the bit-rate of the encoder. In this regard, the better the rate control.

The encoder buffers 150A through 150N receive the encoded GOP service set of different bit rates from corresponding GOP coding modules 150A through 150N.

As described above, the embodiment of FIG. 1C accomplishes rate control by preprocessing alone, multi-pass encoding alone, or preprocessing in combination with multi-pass encoding. Essentially, the closer the ratio of the actual number of bits to encoder bit-rate across the output of GOP coding modules 150A through 150N, any given GOP service set arrives at the switch 114 at the same time. In this regard, switching among different bit rates of the same service set on the boundary of corresponding encoded GOPs of the same service set results in seamless switching and this a good viewing experience by a viewer of whatever channel is switched.

The multi-rate encoders described in FIGS. 1A-C include encoder sets operable to receive a same video source stream and transmit multiple encoded streams of the same video source stream at different bit-rates. As described above, the video source streams 102A-N may include raw video in display order. In another embodiment, the video source streams 102A-N comprise encoded video. In this embodiment, the first encoder in the encoder set, such as the encoder 106A shown in FIGS. 1B and 1C, is essentially a pass-through for the encoded video in the received encoded video stream, and the encoders 106B-N are transraters that generate the encoded stream at different bit rates.

Examples of methods in which the multi-rate encoder 100 may be employed to encode video data will now be described with respect to the following flow diagrams of the methods 200, 300, and 306 depicted in FIGS. 1A, 1B, 1C, and 2.

The descriptions of the methods 200, 300, and 306 are made with reference to the multi-rate encoder 101 shown in FIGS. 1A, 1B, and 1C, and thus make reference to the elements cited therein. However, it should, be understood that the methods 200, 300, and 306 are not limited to the elements set forth in the multi-rate encoder 101. Instead, it should be understood that the methods 200, 300, and 306, may be practiced by a multi-rate encoder having a different configuration than that set forth in the multi-rate encoder 101.

Some or all of the operations set forth in the methods 200, 300, and 306 may be contained as utilities, programs, or subprograms, in any desired computer accessible medium. In addition, the methods 200, 300, and 306 may be embodied by computer programs, which may exist in a variety of forms both active and inactive. For example, they may exist as software program(s) comprised of program instructions in source code, object code, executable code, or other formats. Any of the above may be embodied on a computer readable medium, which include storage devices. Also note that modules described above may be hardware only, software only, or a combination of hardware and software. Exemplary computer readable storage devices include conventional computer system RAM, ROM, EPROM, EEPROM and magnetic or optical disks or tapes.

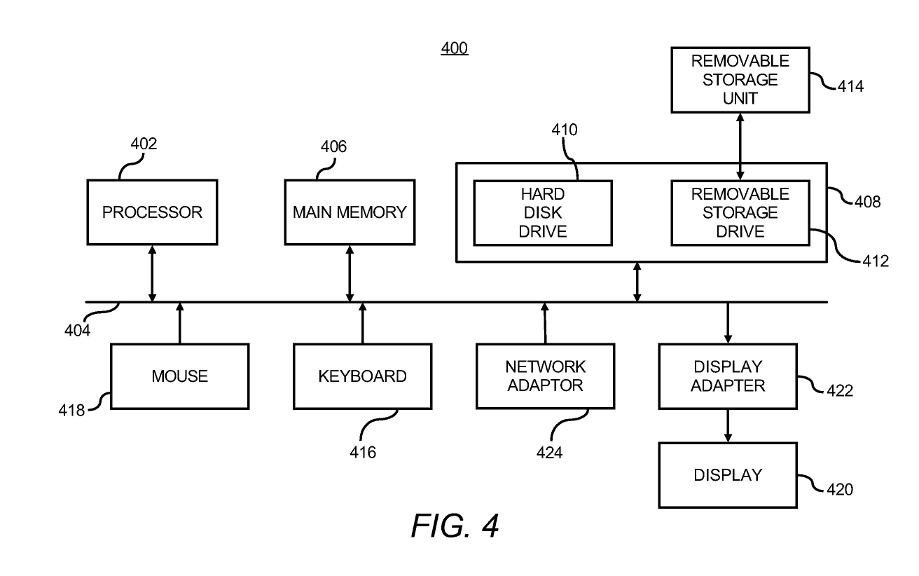

A controller, such as a processor (shown in FIG. 4), ASIC, microcontroller, etc., may implement or execute the multi-rate encoder 100 to perform one or more of all three of the methods 200, 300, and 306. Alternatively, the multi-rate encoder 100 may be configured to operate independently of any other processor or computer device.

With reference first to the embodiment of FIG. 2, there is shown a flow diagram of a method 200 of multi-rate encoding according to an embodiment. Also the methods, 200, 300, and 306 are described with respect to one or more of FIGS. 1A through 1C by way of example and are therefore not limited by the embodiments of FIGS. 1A through 1C.

At step 201, a video source stream is received at multiple encoders. For example, video source 102A is received at encoders 106A through 106N.

At step 202, the video source stream is aligned among the video encoders. For example, GOP coding modules 138A through 138N start encoding the same frame of the video source 102A, and encoding may start at the same time.

At step 203, the aligned video source stream is encoded at each of the multiple encoders to create multiple encoded video streams of different bit rates.

At step 204, the multiple encoded video streams are aligned relative to each other.

At step 205, the multiple encoded video streams are transmitted in alignment. For example, the transport rate buffers 144A through 144N and the transport rate control module 145 transmit GOPs so the switch 114 receives the same GOP of different bit rates at the same time (within some tolerance). The switch 114 may switch between the different bit rate streams as needed based on available bandwidth and other factors with minimal perceived degradation by the subscriber.

Turning now to FIG. 3A, there is illustrated a flow diagram of method 300 for multi-rate encoding, according to an embodiment. Some of the steps contained in the method 300 are similar to the steps discussed above with respect to the method 200 as well as with respect to the embodiments of FIGS. 1A, 1B and 1C. Generally speaking, the method 300 provides a description of preprocessing video data after alignment of the GOPs at the multi-rate encoder 101 but before encoding such as in the above-described manner with respect to the embodiment of FIG. 1C.

In this regard, FIG. 3A illustrates a method 300 for aligning and preprocessing unencoded GOPs to accomplish rate control for transmission, according to an embodiment.

At step 301, a video source stream is received.

At step 302, the video source stream is aligned according to the above-disclosed embodiments of FIGS. 1A, 1B, 1C, and 2.

At step 303, the video source stream is preprocessed according the above-description with respect to FIGS. 1A and 1C.

At step 304, the encoded service set is encoded according to the above-disclosed embodiments of FIGS. 1A, 1B, 1C, and 2. The aligned video source streams are encoded to create a service set including streams of multiple encoded GOPs of different bit rates. In one example, one stream is at a constant bit-rate and other streams are encoded at a percentage lower bit rate.

At step 305, the transmission of each encoded GOP occurs after the expiration of the previous GOPs gop_time of the highest rate encoded GOP according to the above-disclosed embodiments of FIGS. 1A, 1B, 1C, and 2. Essentially, by transmitting each encoded GOP on or after expiration of the gop_time of the highest bit-rate encoded GOP (on a GOP-by-GOP basis), the transmitted encoded GOPs are transmitted in a manner so as to be received by the switch the switch 114 at the same time (within some tolerance).

Turning now to FIG. 3B, there is illustrated a flow diagram of a method 306 for multi-rate encoding, according to an example. Some of the steps contained in the method 306 are similar to the steps discussed above with respect to the methods 200 and 300, as well as with respect to the embodiments of FIGS. 1A, 1B and 1C. Essentially, FIG. 3B illustrates a method 306 for multi-pass encoding, according to an embodiment.

At step 307, a video source stream is received.

At step 308, GOPs are aligned similar to the above-disclosed embodiments of FIGS. 1A, 1B, 1C, 2, and 3A.

At step 309, preprocessing the video stream similar to the above-disclosed embodiments of FIGS. 1C and 3A may be performed as option.

At step 310, the aligned video source stream is multi-pass encoded according to the above-description with respect to FIG. 1C.

At step 311, on a GOP service set by GOP service set basis, each service set is transmitted to the switch 114 on or after the expiration of the previous GOPs gop_time of the highest bit-rate encoded GOP according to he above-disclosed embodiments of FIGS. 1A, 1B, 1C, 2, and 3A. Essentially, transmitting each GOP service set on or after the gop_time of the highest rate encoded GOP results in a situation where each GOP, in any given service set, arrives at switch 114 at the same time. Therefore, the switch 114 may seamlessly switches on GOP boundaries among different rates of the same.

FIG. 4 illustrates a block diagram of a computer apparatus 400, configured to implement or execute the methods 200, 300a, and 300b as depicted in FIGS. 2, 3A, and 3B, according to an example. In this respect, the computing apparatus 400 may be used as a platform for executing one or more of the functions described hereinabove with respect to the multi-rate encoder 101 shown in FIGS. 1A, 1B, and 1C.

The computer apparatus 400 includes a processor 402 that may implement or executive some or all of the steps described in the methods 200, 300a, and 300b. Commands and data from the processor 402 are communicated over a communication bus 404. The computer apparatus 400 also includes a main memory 406, such as a random access memory (RAM), where the program code for processor 402 may be executed during runtime, and a secondary memory 408. The secondary memory 408 includes, for example, one or more hard disk drives 410 and/or removable storage drive 412, representing a floppy diskette drive, a magnetic tape drive, a compact disk drive, etc., where a copy of the program code for the methods 200, 300a, and 300b may be stored.

The removable storage drive 410 reads from and/or writes to a removable storage unit 414 in a well-known manner. User input and output devices may include a keyboard 416, a mouse 418, and a display 420. A display adaptor 422 may interface with the communication bus 404 and the display 420 and may receive display data from the processor 402 and convert the display data into display commands for the display 420. In addition, the processor(s) 402 may communicate over a network, for instance, the Internet, LAN, etc., through a network adaptor 424.

It will be apparent to one of ordinary skill in the art that other known electronic components may be added or substituted in the computing apparatus 400. In addition, the computer apparatus 400 may include a system board or blade used in a rack in a head end, central office, neighborhood node, a conventional “white box” server or computing device, etc. Also, one or more of the components in FIG. 4 may be optional (for instance, user input devices, secondary memory, etc).

This present invention may also be implemented wirelessly by using a combination of wired and wireless infrastructure. Furthermore, in any situation where a cable television system becomes band-limited, the present invention may be used to deliver video over such a cable system, or any other band-limited network.

What has been described and illustrated herein are embodiments of The embodiments along with some of their variations. The terms, descriptions and figures used herein are set forth by way of illustration only and are not meant as limitations. Those skilled in the art will recognize that many variations are possible within the spirit and scope of The embodiments, wherein The embodiments is intended to be defined by the following claims—and their equivalents—in which all terms are mean in their broadest reasonable sense unless otherwise indicated.

What is claimed is:

1. A multi-rate encoder comprising:
at least one encoder set
including multiple encoders receiving a same video source stream and being configured to transmit multiple encoded streams of the same video source stream at different bit-rates;
wherein each encoder set is configured to
align the same video source stream among the multiple encoders on a same unencoded picture of the same video source stream,
align the multiple encoded streams on a corresponding boundary of a same encoded GOP service, and
transmit the encoded GOP service set in alignment;
the multiple encoders of the at least one encoder set including
a first encoder receiving the same video source stream and encoding the same video source stream at a first bit rate of the different bit-rates; and
a second encoder receiving the same video source stream and encoding the same video source stream at a second bit rate of the different bit-rates.

2. The multi-rate encoder according to claim 1, wherein the at least one encoder set further comprises:
a master encoder comprising an alignment module, and an alignment control module; wherein the alignment module is operable to control alignment of the received video source stream in response to the alignment control module; and
a slave encoder comprising an alignment module; wherein the alignment module of the slave encoder is operable to align the received video source stream with respect to the aligned video source stream of the master encoder in response to the alignment control module of the master encoder.

3. The multi-rate encoder according to claim 2, wherein the master encoder further comprises a GOP coding module and a master coding control module;
wherein the slave encoder further comprises a GOP coding module; and
wherein the GOP coding module of the master encoder and the GOP coding module of the slave encoder are controlled by the master coding control module of the master encoder to encode the same unencoded picture on the boundary of an unencoded GOP.

4. The multi-rate encoder according to claim 3, wherein the master encoder further comprises a transport rate buffer and a master transport rate control module;
wherein the slave encoder further comprises a transport rate buffer; and
wherein the transport buffer of the master encoder and the transport rate buffer of the slave encoder are controlled by the master transport rate control module to send the an encoded GOP of different bit rates in alignment.

5. A method of coding a video source stream comprising:
receiving an unencoded video source stream at multiple encoders;
aligning the unencoded video source stream among the multiple encoders;
encoding the aligned unencoded video source stream at each of the multiple encoders to create a service set of multiple encoded video streams of different bit rates; and
transmitting the multiple encoded video streams.

6. The method of claim 5, further comprising:
prior to transmitting the multiple encoded video streams, aligning the multiple encoded video streams of different bit rates among the output of the multiple encoders; and
the transmitting includes transmitting the multiple encoded video streams in alignment.

7. The method according to claim 5, wherein the step of aligning the unencoded video source stream further comprises:
aligning the unencoded video source stream on a common GOP boundary.

8. The method according to claim 7, wherein the step of aligning the unencoded video source stream further comprises:
comparing a metric determined by each encoder of an encoded picture received by each encoder.

9. The method according to claim 8, wherein the step of encoding the aligned unencoded video source stream further comprises:
allocating multiple GOP bit budgets according to a rate control function to create a set of multiple encoded GOPs of different bit rates in the service set, wherein the allocating occurs on an encoded GOP by encoded GOP basis.

10. The method according to claim 9, wherein the step of encoding the aligned video source stream further comprises:
storing each set of multiple encoded GOPs, wherein said storing occurs on an encoded GOP by encoded GOP basis.

11. The method according to claim 10, wherein each set of multiple encoded GOPs comprises a highest bit-rate encoded GOP and one or more encoded GOPs of different lower bit rates.

12. The method according to claim 11, wherein the step of encoding the aligned unencoded video source stream further comprises:
dividing the bit-rate of the highest rate encoded GOP in each set of multiple encoded GOPs by the number of encoded bits therein, wherein said step of dividing calculates a gop_time in which to transmit each set of multiple encoded GOPs, and wherein said step of dividing occurs on an encoded GOP by encoded GOP basis.

13. The method according to claim 12, wherein each highest bit-rate encoded GOP is encoded by a fixed constant bit-rate encoder, and each lower bit-rate encoded GOP is encoded by a corresponding variable lower bit-rate encoder, and the ratio of target encoded gop_bits to encoded bit-rate is the same for each encoder.

14. The method according to claim 13 wherein each highest bit-rate encoded GOP is encoded by a capped variable bit-rate encoder, and each lower bit-rate encoded GOP is encoded by a corresponding capped variable lower bit-rate encoder, and the ratio of encoded target gop_bits to encoded bit-rate is the same for each encoder on an encoded GOP by encoded GOP basis.

15. The method according to claim 11, further comprising at least two of the multiple bit-encoders creating a different encoded GOP structure from the same aligned unencoded GOP.

16. The method according to claim 11, wherein the step of transmitting the multiple encoded video streams further comprises:
computing a transport rate of each stored set of multiple encoded GOPs, wherein said computing occurs on an encoded GOP by encoded GOP basis.

17. The method according to claim 5, wherein transmitting the multiple encoded video streams further comprises:
determining a master time stamp for a master encoder of the multiple encoders; and
embedding the master time stamp into each of the multiple encoded video streams, wherein the master time stamp is used to synchronize decoding of any of the streams.

18. The method of claim 5, wherein encoding the aligned unencoded video source stream at each of the multiple encoders to create a service set of multiple encoded video streams of different bit rates comprises
encoding the aligned unencoded video source stream to create multiple streams of encoded GOPs of different bit rates, wherein said encoding occurs on an unencoded GOP by unencoded GOP basis; and
transmitting each encoded GOP on or after expiration of the encoded gop_time.

19. The method according to claim 18, further comprising:
receiving each stream of encoded GOPs;
selecting a stream of encoded GOPs on a boundary of a GOP service set;
transmitting the selected stream of encoded GOPs;
switching from the selected stream of encoded GOPs to another stream of encoded GOPs; and
transmitting the switched stream of encoded GOPs.

20. The method according to claim 19, wherein the step of encoding further comprises:
calculating a different video buffer verifier for each stream of encoded GOPs, wherein the calculating occurs on an encoded GOP by encoded GOP basis; wherein the calculating further comprises subtracting an offset from an available size of a decoder buffer verifier; and
wherein each offset is computed on an encoded GOP by encoded GOP basis by multiplying a system delay by the difference between the encoded bit-rate of the highest rate encoder and the encoded bit-rate of the switched bit-rate encoder.

21. A computer readable storage medium on which is embedded one or more computer programs, the one or more computer programs implementing a method for encoding a video source stream, the one or more computer programs comprising computer readable code for:
receiving an unencoded video source stream at multiple encoders;
aligning the unencoded video source stream among the multiple encoders;
encoding the aligned unencoded video source stream at each of the multiple encoders to create a service set of multiple encoded video streams of different bit rates; and
transmitting the multiple encoded video streams.

22. The computer readable storage medium according to claim 21, wherein prior to transmitting the multiple encoded video streams, aligning the multiple encoded video streams of different bit rates among the output of the multiple encoders; and
the transmitting includes transmitting the multiple encoded video streams in alignment.

23. The computer readable storage medium according to claim 22, further comprising computer readable code for aligning the unencoded video source stream on a common GOP boundary.

24. The computer readable storage medium according to claim 22, further comprising computer readable code for:
allocating multiple GOP bit budgets according to a rate control function to create a set of multiple encoded GOPs of different bit rates in the service set, wherein the allocating occurs on an encoded GOP by encoded GOP basis.
